(19) United States
(12) Patent Application Publication
(10) Pub. No.: US 2009/0215019 A1
(43) Pub. Date: Aug. 27, 2009

(54) System and method for interactive education

(75) Inventor: Timothy Cresci, Bal Harbour, FL (US)

Correspondence Address: ANDREW F. KNIGHT, 124 South Hampton Drive, Vinton, VA, 24179, US

(73) Assignee: Hydro-Innovation Corp.

(21) Appl. No.: 12/387,209

(22) Filed: Apr. 29, 2009

Related U.S. Application Data
(60) Provisional application No. 61/126,975, filed on May 9, 2008.

(51) Int. Cl. G09B 7/00; G09B 5/00

(52) U.S. Cl. 434/350; 434/308; 434/362

(57) ABSTRACT

A method for interactive education includes publicly broadcasting an educational program at a first time, inciting a user to record the educational program, inciting a student to view the educational program at a second time later than the first time, inciting the student to use a computer processor and an information connection to log into an education server, and inciting the student to input information regarding the educational program into the education server.

### REFERENCE TO RELATED APPLICATIONS

The present application claims priority to U.S. Provisional Patent Application No. 61/126,975, filed May 9, 2008, entitled “Interactive TV based on the local newspaper website.”

### BACKGROUND

Modern education typically occurs in classrooms. In the digital age, classroom environments can be simulated over the Internet with an educational program transmitted to a student via the Internet. Further, in a live Internet presentation, a student may interact with the teacher during the presentation by transmitting her voice, text, and/or image to the teacher via the Internet.

### SUMMARY OF THE INVENTION

One problem with education via the Internet is that the bandwidth of Internet access is not sufficiently high to carry a streaming, high-resolution video at typical refresh rates (e.g., 30 frames per second). Also, the addition of sound information further erodes the quality of the video information. Interactive education will have the highest quality when taking advantage of the relatively high bandwidth of cable and television broadcasting.

There are several problems with learning through broadcast educational programs. First, if the programs are broadcast publicly, the broadcast must be funded, an expense that must be passed on to students. One possible solution is to broadcast during the least demanded (and thus least expensive) hours, such as between 12 a.m. and 6 a.m., and more particularly between 2 a.m. and 4 a.m., and then encourage or incite students to automatically record the educational programs during this time period. Modern recording devices, such as TIVO™ or other digital recording devices, can be programmed to record programming at any predetermined time. The educational program can then be replayed at a later time. Second, traditional commercial advertising, targeted specifically to the students of the educational program (or a relevant demographic), can be used to fund the programming and broadcast. Another solution is to merge local broadcasters with local newspapers in order to free up resources that can be used for the production and broadcasting of educational programs. For instance, a television broadcaster, which has an affiliated website, may combine its website with that of a local newspaper, to thereby consolidate and more efficiently use resources.

Another problem with broadcast-type education is that it if a student is directed to visit a particular website via a web address or URL (uniform resource locator), the student must explicitly type the URL into a web browser on her computer, which is clumsy, annoying, and error-prone. There is a need for a system and method to automatically direct a student's web browsers to the desired websites.

According to an embodiment of the present invention, a method for interactive education comprises: publicly broadcasting an educational program at a first time; inciting a user to record the educational program; inciting a student to view the educational program at a second time later than the first time; inciting the student to use a computer processor and an information connection to log into an education server; and inciting the student to input information regarding the educational program into the education server. The student and user may or may not be the same person or entity.

In an aspect, the method further comprises broadcasting a commercial advertisement immediately before, during, or immediately after the educational program. In an aspect, the method further comprises: inciting a local television broadcaster to merge with a local newspaper to thereby free resources; and using the freed resources at least in part to produce the educational program. In an aspect, the input information corresponds to at least one of: answers to a test related to the educational program; a question related to the educational program; and attendance related to the educational program. In an aspect, the first time occurs at some period between 12 a.m. and 6 a.m. In an aspect, the second time occurs at least two hours after the first time. In an aspect, the method further comprises: communicating a web address through the educational program; and inciting the student to use the computer processor and the information connection to access information identified by the web address. In an aspect, the method further comprises: communicating information corresponding to a web address through the educational program; and causing the student to access information identified by the web address via the computer processor and the information connection, said causing comprising at least one of: transmitting a sound that is receivable and decodable by the computer processor; and transmitting electromagnetic radiation that is receivable and decodable by the computer processor.

According to an embodiment of the present invention, a method for interactive education comprises: publicly broadcasting an educational program; inciting a student to use a computer processor and an information connection to log into an education server; inciting the student to input information regarding the educational program into the education server; communicating a web address through the educational program; and inciting the student to use the computer processor and the information connection to access information identified by the web address.

In an aspect, the web address corresponds to a website of a local television broadcaster. In an aspect, the web address corresponds to a website of a local newspaper. In an aspect, the educational program is affected at least in part by the information input by the student. In an aspect, the method further comprises broadcasting a commercial advertisement immediately before, during, or immediately after the educational program. In an aspect, the method further comprises: inciting a local television broadcaster to merge with a local newspaper to thereby free resources; and using the freed resources at least in part to produce the educational program. In an aspect, the input information corresponds to at least one of: answers to a test related to the educational program; a question related to the educational program; and attendance related to the educational program.

According to an embodiment of the present invention, a method for interactive education comprises: publicly broadcasting an educational program; communicating information corresponding to a web address through the educational program; and causing a student to access information identified by the web address via a computer processor and an information connection, said causing comprising at least one of: transmitting a sound that is receivable and decodable by the computer processor; and transmitting electromagnetic radiation that is receivable and decodable by the computer processor.

In an aspect, the method further comprises providing the student with a hand-held controller connected to the computer processor and configured to provide a point sight on a display displaying the educational program and to read the information corresponding to the web address. In an aspect, said causing comprises transmitting a sound that is receivable and decodable by the computer processor. In an aspect, said causing comprises transmitting electromagnetic radiation that is receivable and decodable by the computer processor. In an aspect, said publicly broadcasting comprises at least one of radio television broadcasting, cable television broadcasting, and satellite television broadcasting, and does not comprise Internet broadcasting.

### BRIEF DESCRIPTION OF THE DRAWINGS

FIG. 1 shows a flow diagram of a method according to an embodiment of the present invention.

FIG. 2 shows an interactive education system according to an embodiment of the present invention.

### DETAILED DESCRIPTION

In the following description, the use of “a,” “an,” or “the” can refer to the plural. All examples given are for clarification only, and are not intended to limit the scope of the invention.

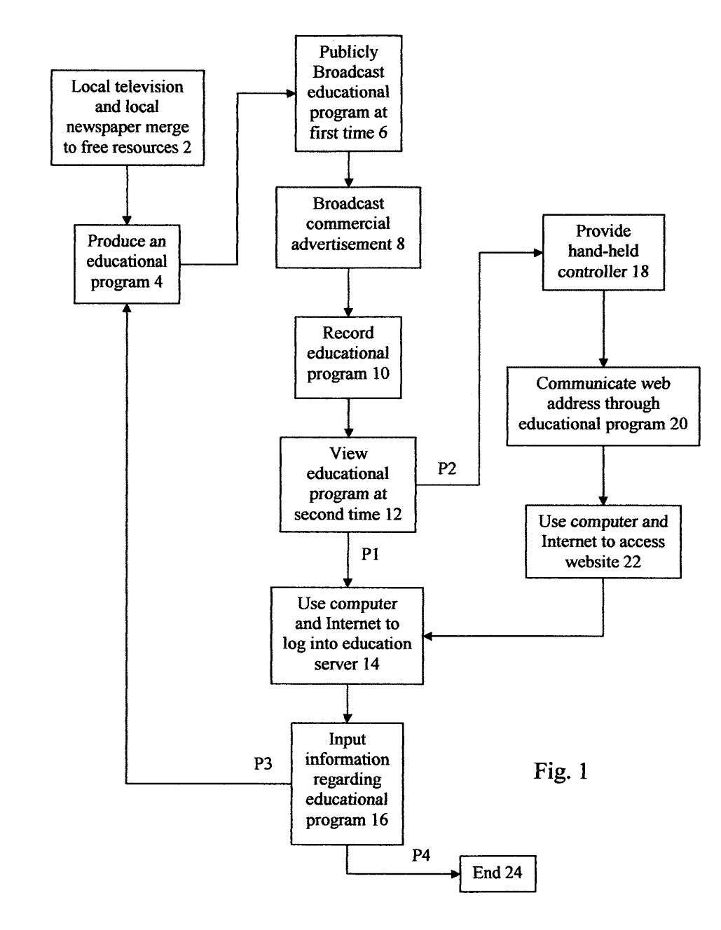

Referring now to FIG. 1, a method for interactive education comprises merging 2 a local television broadcaster and a local newspaper to free resources, producing 4 an educational program, publicly broadcasting 6 the educational program at a first time, broadcasting 8 a commercial advertisement, recording 10 the educational program, viewing 12 the educational program at a second time, using a computer processor and an information (e.g., Internet) connection to log into an education server 14, inputting information 16 regarding the educational program into the education server, providing 18 a hand-held controller to a student, communicating 20 a web address through the educational program, and using the computer processor and information connection to access 22 the website. The process shown in FIG. 1 ends at reference number 24.

The flow in FIG. 1 is shown to begin at step 2, but could start at any other step, such as steps 4 or 6. Further, the flow, which will be discussed in more detail later, includes several possible paths P1-P4 that depend on the preferences or desires of the user of the present invention. Not all steps are necessary, and the invention shown in FIG. 1 need not include all steps relevant or preferred by a user of the present invention.

The step of merging 2 a local television broadcaster and a local newspaper to free resources is very broad in scope. It could include, for instance, a merger so that a single entity owns both the television broadcaster and the newspaper, or the purchase by one of a controlling interest and/or a majority of assets of the other. As another example, the television broadcaster could purchase the “name” and other trademarks and intellectual property of the newspaper if the newspaper is in bankruptcy or other financial crisis. Ultimately, instead of competing, the television broadcaster and newspaper merge by combining forces to take advantage of their respective strengths to maximize advertising revenues, readership, consumption, etc. Such combinations/mergers often result in increases in efficiency which free up financial and other resources. These resources may be used for any purpose, such as growing the company, distribution to shareholders, or producing other media works for public consumption, such as educational programming.

The step of producing 4 an educational program includes any act or step involved in creating an educational program that can then be broadcast by any known electronic means. For instance, the step may include by is not limited to: inciting a teacher or actor to provide a lecture, educational demonstration, or other program; filming and/or audio sensing the program using a video camera, microphone, or other sensing device; recording the program by converting the signals into digital or analog information, and storing that information on a storage device, such as a magnetic video tape, a hard drive, an optical media device (e.g., DVD), and so forth. The educational program could be related to an educational course offered by a middle school, high school, college, university, technical school, local school board, or other public or private educational institution.

Next, the step of publicly broadcasting 6 the educational program at first time includes, broadly, the transmission of an electronic signal representing the educational program via a publicly accessible medium, such as cable television, satellite television, and radio transmission television (the latter of which is “ordinary” television transmission that involves transmission of video and audio signals over radio frequencies, usually UHF and VHF). “Public broadcasting,” as used in the present application, includes any broadcasting that is freely available and accessible to a general or public populace either at no cost (such as radio transmission broadcasting through VHF or UHF frequencies) or for the cost of providing and delivering service (such as cable or satellite TV). “Public broadcasting” does not include private networks accessible exclusively by a group of members, such as educational networks accessible only by registered or enrolled students. Further, “public broadcasting” is not limited to activities that are funded publicly or are not-for-profit, as the phrase may be colloquially used (e.g., the Public Broadcasting Service (PBS)). The activities may be funded, controlled, operated, etc., by private owners or entities and/or for-profit.

The “first time” at which the educational program is publicly broadcasted may be at some time in the middle of the night, such as between 2 a.m. and 4 a.m., or more broadly from 12 a.m. to 6 a.m., or the “first time” may be during more “prime” or “peak” hours, such as during the morning from 6 a.m. to 9 a.m.

Because people generally watch television programming at the time of each program's scheduled broadcast, the demand (and advertising price) for air time during certain periods of the day are higher than at others. Thus, “prime time” is most heavily watched by viewers and also costs the most to advertisers. Conversely, programming in the middle of the night, such as between 2 a.m. and 4 a.m., or more broadly from 12 a.m. to 6 a.m., has the lowest viewership, demand, and advertising cost. In fact, many television stations or cable channels do not even broadcast programming during some of these hours.

However, with the advent of easy-to-use digital recording devices with built-in timers, such as TIVO™ and automatic DVD recorders, there is much greater flexibility in watching targeted programming, which may increase the value of middle-of-the-night airtime. One option, in the case of educational programming, would be to air such programming during these off-peak times, especially in the middle of the night, and then incite or encourage users/viewers to automatically record 10 the educational programming for later viewing. Thus, in one embodiment, the public broadcasting 6 could occur at a first time between 2 a.m. and 4 a.m., for example, and the educational program could be recorded 10 for playback and viewing 12 at a second time which is later than the first time. The second time, for instance, could occur at least two hours after the first time. Such recording 10 could occur with use of a recording device with an automatic timer.

Further, in order to provide revenues necessary to provide for this educational programming, the method may include the step of broadcasting 8 commercial advertising before, during, or after the educational program. Such advertising could be specifically targeted to those who are watching the program or to a general demographic associated with the educational program. In the former case, the advertising could, for example, be related directly to something needed or desired by those taking a college course for which viewing the educational program is a requirement, such as an advertisement for a college bookstore. In the latter case, the advertising could be related to the desires and needs of students in general, such as inexpensive pizza, computers, or spring break vacation packages.

Next, a user or student may then view 12 the educational program at second time by replaying the recorded programming on his television or other display, through use of the video recording device. For instance, even though a user (such as the student's parent) set up a digital video recorder to automatically record 10 the educational program as it was broadcasted at the first time (such as at 3 a.m.), the student may then replay and view 12 the program at the second time (such as at 7 a.m.), which is later than the first time.

Following path P1 in FIG. 1, the student may then use a computer processor (such as a personal computer, laptop, etc.) and an information connection (such as the Internet, local area network, wide area network, and so forth) to access and log into an education server 14 corresponding to the educational entity (university, high school, local school board, etc.) responsible for producing, distributing, broadcasting, or otherwise affiliated with the educational program. An example follows. In a certain academic course (such as calculus) offered by ABC College (such as part of a degree program or structured course of study), the college requires its calculus students to view an educational program, which may be a lecture on calculus taught by a professor at ABC College. Before, during, or after viewing the educational program, each student logs into the ABC College website 14 (or a particular website associated with the calculus course at ABC College) via an information connection between the student's computer processor and ABC College's online server. “Logging in” is a term of art well known by those of ordinary skill in the art, and may include providing or inputting credentials into a website (which may or may not be secure), such as a username and/or password or other data, such as an address or contact information, private identification information (e.g., mother's maiden name, date of birth, etc.), and so forth. The logging in process may further include authentication of the inputted information and then providing access to the user to one or more websites (or other information) for which successful login is a prerequisite.

Once logged in, the student may then input information 16 regarding the educational program into the education server. For instance, the educational website or server may ask the student questions regarding the educational program, to which the student may then answer. In this regard, the student may take a test, quiz, or other performance evaluation information exchange while logged into the educational server via her computer processor and information connection. The student's performance regarding the course and/or educational program, attendance, contributions, or other relevant metrics may then be measured by information inputted by the student into the educational server after being logged on. Further, the information inputted may include questions, comments, or feedback for the instructor/lecturer of the educational program or other people, including fellow classmates, members of the educational administration, and so forth.

The combination of public broadcast with the interactivity of an Internet connection helps to maintain the interactivity of a conventional online education course while substantially improving the bandwidth available for presentation of information to students. By allowing public broadcast of the educational program over conventional broadcast media (radio TV, satellite TV, cable TV, etc.) during off-peak hours, inciting users and/or students to record, replay, and view the educational program at a later time, and inciting students to log into and input information into an educational server regarding the educational program, a student can enjoy a more realistic, information-packed, and enjoyable educational course while retaining online interactivity with the teacher/lecturer, administration, other students, and so forth.

Following path P3 in FIG. 1, the information inputted 16 by the student may or may not affect the production of the educational program. For instance, where the student asks a question via his information connection with the educational server, the teacher/lecturer may then address and/or answer that question in a subsequent educational program that, again, will be publicly broadcasted. In an alternative embodiment, in which the student views 12 the educational program at approximately the same time as the production, and live broadcast of the educational program—i.e., in which the first and second times are essentially the same and the program is broadcasted live—the information inputted in step 16 may immediately affect the educational program. For instance, a student may ask a question or make a comment while logged into the educational server, and the teacher/lecturer may instantly receive the question/comment and address it during the live broadcast. Alternatively, if the information inputted in step 16 does not affect a concurrent or future production of an educational program, then the method follows path P4 and ends 24.

In another embodiment, following path P2 after viewing 12 the educational program at the second time, a web address is communicated 20 through the educational program. (For the moment, optional step 18 will be ignored/skipped. This step will be addressed later in a different embodiment.) In one embodiment, the web address is communicated to the student visually by displaying the web address (or URL or other instructions for accessing a particular website) on the student's television screen or monitor. The student then uses his computer processor and information connection to access 22 the website corresponding to the web address. For instance, a teacher/lecturer presenting the educational program may write the web address on a chalkboard or other writing medium, visible to those students watching the program. Alternatively or in addition, text corresponding to the web address may be electronically superimposed over the program using conventional video editing software, as understood by those of ordinary skill in the art. In another embodiment, the web address is communicated to the student orally, verbally, or through other auditory instruction, such as by the teacher/lecturer speaking the name of the web address.

The web address may correspond to any relevant or important website suggested by the teacher/instructor to augment the student's education. For instance, if the educational program is required for ABC College's calculus course, the web address may correspond to a website that displays a variety of calculus equations and formulae, displays common calculus functions, provides input/output features to help the student learn calculus, and so forth. As another example, if the course is a history class, the web address may correspond to one or more articles, descriptions, photos, or videos of a relevant history subject or lesson.

Alternatively or in addition, the web address may correspond to a website owned, used, or operated by a local television broadcaster or local newspaper or other local media The educational material accessible through the communicated web address may be managed or controlled by local media, thus generating and increasing interest by students in local media and increasing viewership/readership of local media outlets. For instance, the website accessed by the communicated web address may include not only educational material corresponding to the subject matter of the educational program, but may include peripheral material that may be of interest to the students and/or online advertising targeted at the specific students (or their general demographic) who are viewing the educational program. The increased interest in local media generated by the suggestion of websites of local media websites and/or the advertising revenue generated by viewing of such websites may help to fund the production 4 of the educational program.

The word “local” as used herein to describe local newspapers, local television stations, or other local media, refers to media whose content is targeted to a geographically restricted region within the United States and is associated with a particular city, county, or metropolitan area. For instance, the newspaper USA Today, which is a national paper not targeted to any particular geographic region within the U.S. or associated with any metropolitan area, would not be considered a “local” newspaper for purposes of the present application, while the Miami Herald would be because its content is targeted to a geographically restricted region within the United States (specifically, southeast Florida) and is associated with the city of Miami.

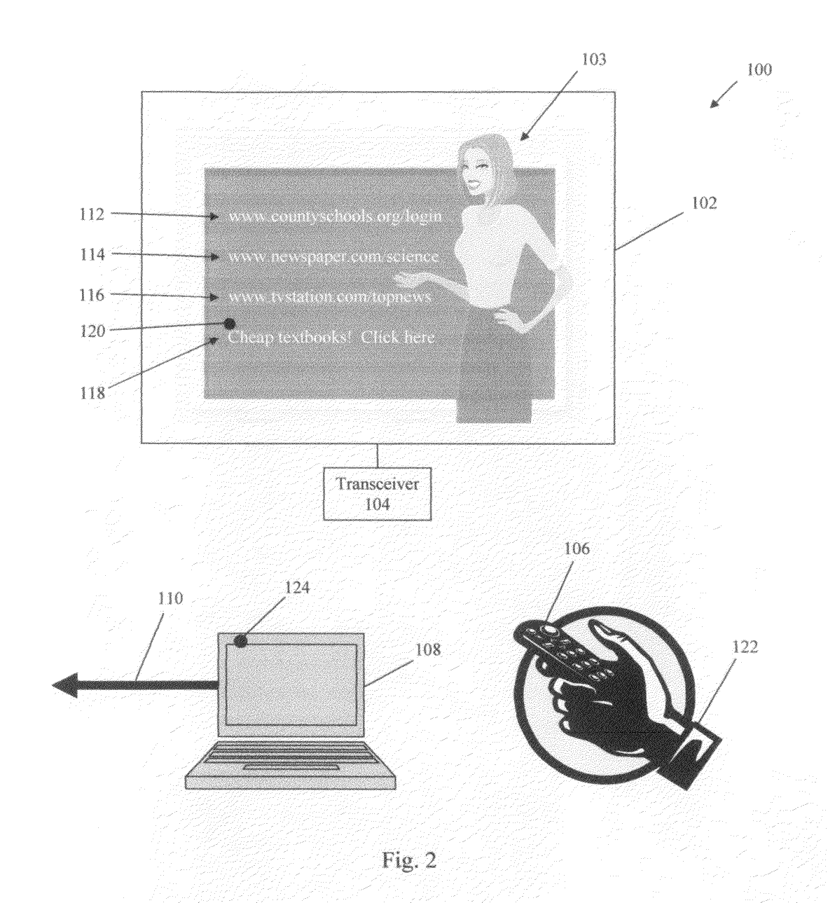

An example will now be provided of the present embodiment. As relates to the present embodiment and referring now to FIG. 2, a system 100 for interactive education includes a television display/monitor 102 displaying an educational program featuring a teacher/lecturer 103. A variety of web addresses are visually displayed, which may have been written by the teacher/lecturer 103 on a chalkboard or otherwise electronically superimposed onto the educational program. A first web address 112 (shown as www.countyschools.org/login) is an example of a web address corresponding to a login webpage of an educational server. For instance, if the student types this URL into an Internet browser on his computer, he will access a login page of the educational server, allowing him to provide proper credentials and then be authenticated and provided access to the educational server.

A second web address 114 (shown as www.newspaper.com/science) is an example of an address corresponding to the website of a local newspaper. The primary web address is www.newspaper.com with the path being “science,” such that when a student types the entire web address into her browser, she accesses and views, for example, one or more articles, links, interactive programs/software, blogs, and so forth regarding science. Thus, if the educational program deals with chemistry, the website accessed by the displayed web address may allow the student to read or learn about chemistry. Further, accessing this webpage may allow the student to browse through the newspaper's website and to increase interest and readership in the newspaper's website and/or the actual newspaper. Further, the webpage may include one or more advertisements targeted to the students or relevant demographic.

A third web address 116 (shown as www.tvstation.com/topnews) is an example of an address corresponding to the website of a local television broadcaster. The primary web address is www.tvstation.com with the path being “topnews,” such that when a student types the entire web address into her browser, she accesses and views, for example, one or more articles, links, interactive programs/software, blogs, and so forth regarding interesting, relevant, or important news stories. Thus, if the educational program deals with the international economy, the website accessed by the displayed web address may allow the student to read or learn about current events regarding the international economy. Further, accessing this webpage may allow the student to browse through the local television station's website and to increase interest and viewership in the station's website and/or the actual television station. Further, the webpage may include one or more advertisements targeted to the students or relevant demographic.

A fourth web address (not shown in FIG. 2, but may read www.cheaptextbooks.com) is an example of a web address corresponding to an advertiser. The advertised web address may be targeted directly to the students (as in the case of low-cost textbooks) or a relevant demographic (as in the case of spring break vacation packages). When the student accesses the webpage corresponding to the displayed web address, he has the option of making a purchase. Some of the profits from this purchase may be used to pay for the advertising of the web address in the educational program, thus allowing costs associated with production and broadcasting to be offset by those who patronize the advertiser's website(s).

In any of the paths or embodiments described herein, one or more steps may be omitted. For instance, in the path designated by P2, the step of recording 10 the educational program for replay later may be omitted. In such an embodiment, the (second) time of viewing 12 may be essentially the same (first) time as public broadcasting 6, so that no recording is necessary.

In the embodiment following path P2 (and ignoring step 18), the communication 20 of a web address (corresponding to or accessing an informative or educational webpage) through the educational program and inciting the student to access 22 the corresponding webpage via his computer processor and information connection helps to increase the value of the educational experience, as well as provide opportunities for advertising and increasing readership/viewership of the associated information media outlets (if any). Once again, the user may log into an educational server 14 and input information 16 into the server, as described previously.

The combination of communicating 20 a web address (and inciting a student to visit or access 22 the corresponding webpage) through a publicly broadcast educational program, along with the interactivity of Internet-based information transfer through an educational server, increases the education value to the student. In the embodiment described with reference to path P2, a student may view a high-resolution (or high-bandwidth) educational program on his television display/monitor, augment his education by visiting websites suggested by the educational program via his Internet browser (on his computer processor interacting with the Internet), and then interact with and input information to the educational server regarding the educational program (and/or websites), such as taking tests, asking questions, or demonstrating attendance.

Further, to the extent possible, the steps indicated in FIG. 1 may be performed in a different order. For instance (but not as a limitation), a student may log into the education server 14 before, during, or after viewing 12 the educational program or before, during, or after accessing 22 the website communicated in step 20.

In another embodiment, consistent with path P2, the student may be provided with a hand-held controller 18, described in more detail with reference to FIG. 2, that has an information connection to the student's computer processor and is configured to “click” on the web address(es) displayed via the student's television display/monitor in the educational program to thereby cause the Internet browser installed on the student's computer to direct to the associated website. In other words, by the addition of step 18, instead of the student having to type in the displayed web address into his Internet browser in step 22, he can simply “point and click” on the web address in the educational program, causing his Internet browser to automatically direct to the desired website.

A more detailed description follows, with reference to FIG. 2. In FIG. 2, the television display/monitor 102 is connected to a transceiver 104 that interacts with hand-held controller 106 held by the student's hand 122. The controller 106 has an information connection with computer 108, which has an information (e.g., Internet) connection 110 to the educational server and/or World Wide Web. The information connection between the controller 106 and the computer 108 may comprise any connection known, wired or wireless, including but not limited to radiofrequencies, light, infrared radiation, sound, any electromagnetic radiation, and so forth.

The transceiver 104 may be configured to measure/receive a signal from the controller 106, such as a position or aim signal, and to superimpose an image (such as an arrow or indicator point 120) onto the television monitor/display 102, representing the aim of the controller 106. The transceiver 104 could create an indicator point 120 on the monitor/display 102 that is visible to the student, allowing the student to point or aim at the desired web address according to the position or aim of the controller 106. When the student presses a corresponding button on the controller 106 (when he has aligned the indicator point 120 with the desired web address, such as fourth web address 118 as shown in FIG. 2), then the transceiver 104 transmits a signal to the controller 106 indicating that the position of the indicator point 120 corresponds to the fourth web address 118. (Alternatively, a sensor or camera within the controller 106 may read or decipher the web address at which it is aimed.) At this point, the controller 106 sends a corresponding signal to the computer 108, causing the computer's Internet browser to direct to the indicated web address. In this embodiment, the student is provided with a hand-held controller 106 connected to the computer processor 108 and configured to provide a point sight 120 on the display/monitor 102 and to read the information corresponding to the web address (e.g., 112).

Alternatively, the controller 106 may operate without the need for transceiver 104. It may, for instance, include a laser (or other) sight/pointer to indicate where on the monitor/display 102 the controller 106 should read the web address, and include a camera or other sensor designed to read and interpret the web address (or other indicia) on the monitor/display 102 where the sight/pointer is aimed. For instance, the sight/pointer could create an indicator point 120 on the monitor/display 102 that is visible to the student, allowing the student to point or aim at the desired web address. When the student presses a corresponding “click” button on the controller 106 (when he has aligned the indicator point 120 with the desired web address, such as fourth web address 118), the controller's sensor senses or images the web address and sends a corresponding signal to the computer 108, causing the computer's Internet browser to direct to the indicated web address.

Any means for determining the position or aim of controller 106, for transmitting this information to transceiver 104, and for superimposing an indicator point 120 onto a monitor/display 102, that are known in the art are within the scope of the present invention. An advantage of this feature is that when a web address or URL is provided or communicated through the educational program, the student need not physically type the address into his Internet browser. By merely pointing the hand-held controller 106 at the monitor/display 102 and “clicking” on the desired web address or advertisement, the controller 106 can read the associated web address (either through a combination of pointer and video sensor in the controller 106 itself, or through a combination of a controller 106 interacting with a transceiver 104 connected to the monitor/display 102) and then direct the Internet browser on computer 108 to the corresponding website.

Further, the actual URL corresponding to a particular website need not be displayed. For instance, link 118 (which reads “Cheap textbooks! Click here”) may be embedded with a specific URL such that when the student “clicks” on the link 118 with controller 106, the actual information sent to computer 108 corresponds to the web address linked to the displayed advertisement.

In another embodiment, consistent with path P2 in FIG. 1, the step of providing 18 a hand-held controller may be omitted, the step of communicating 20 the web address may be performed specifically for an appropriately configured computer, and the step of accessing 22 the corresponding website may be done automatically by the appropriately configured computer. For instance, with reference again to FIG. 2, the computer 108 may include a sensor/receiver 124 which, along with appropriate software installed on the computer 108, is configured to receive and interpret signals from the display/monitor 102 to cause the computer's Internet browser to automatically direct to a website instructed by the educational program.

For instance, when the teacher/instructor 103 wants her students to access a particular website, the educational program may be embedded with a signal that can be sensed and interpreted/decoded by computer 108 to cause the computer's Internet browser to automatically direct to the website. For example, the sensor/receiver 124 may be a camera that is aimed at the display/monitor 102, and the educational program (via the display/monitor 102) may emit a signal detectable by the sensor/receiver 124. Sending information via electromagnetic radiation (in the visible spectrum, radio frequencies, infrared, etc.) is very well known in the art, and any such known methods are within the scope of the present invention. A simple but crude example might be the flashing of a bar code on the display/monitor 102 which is measured by sensor/receiver 124 and interpreted by computer 108 as the desired web address.

However, the signal generated by the educational program (via display/monitor 102) may not even be visible or, if it is, may be unintelligible or unnoticeable by the student. The signal could be a series or flickering of different colors, a changing of contrast or brightness, a series of on-off dots or other images in the corner of the display/monitor 102, and so forth. The possibilities are endless, and the present invention encompasses the use of any visible or other electromagnetic radiation, including radio waves transmitted by the broadcaster, to carry the signal of a desired web address. Alternatively or in addition, the signal could be a sound signal, and sensor/receiver 124 may be a microphone configured to receive the sound signal. The computer 108 is then configured via software and hardware to interpret or decode the information sensed from the educational program (via display/monitor 102) to a usable web address and then directs its Internet browser to the corresponding website.

It is well known how to carry information over an existing information packet through superimposition of information. For instance, by modulating the frequency or amplitude of the educational program's video or sound in a measurable fashion, information can be transmitted to the computer 108 via sensor/receiver 124 without being detected or noticed by the student, so that the student is not distracted or bothered by transmission of this web address information from the display/monitor 102 to the computer 108.

In this embodiment, the step of using a computer processor and information connection to access 22 a website may include causing a student to automatically access the website by transmitting a sound or electromagnetic radiation that is receivable and decodable by the computer processor.

Any of the steps shown in FIG. 1 may be performed by any actor, such as students, parents, teachers, members of a school board, broadcasters, publishers, and so forth. For instance, the step of publicly broadcasting 6 an educational program may be performed by a broadcaster; the step of recording 10 the educational program may be performed by a parent of a student; and the step of viewing 12 the educational program may be performed by the student. The steps may be performed by a single person or entity, or by several different people/entities.

The word “incite” as used herein may mean to encourage, to compel, to entice, to instruct, to order, to require, or to otherwise cause another to act. For instance, inciting a user to record an educational program may include, but is not limited to, any of the following examples: providing the user a set of instructions including the step of recording the educational program; telling the user to record the educational program; requiring the user to record the educational program as part of an educational course requirement; suggesting to the user that the user will benefit in some manner by recording the educational program; and so forth.

The present invention includes any combination of the steps described herein, as well as any combination in which one or more of the steps is performed by one who was incited to perform the step by another. For instance, if inventive combination of steps A, B, and C is performed by three different entities or people, then no single person would literally infringe (under 35 U.S.C. 271(a)) on the claim comprising the combination of steps A, B, and C, even though one or more of the entities may have actively induced infringement under Section 271(b). However, if the claimed combination comprises the steps of performing A, inciting another to perform step B, and inciting another to perform step C, then a single person or entity may literally infringe the claim under Section 271(a).

The present invention is not limited to educational programming. For instance, the image shown on display/monitor 102 in FIG. 2 may correspond to a local news, variety, auction, talk, or classifieds show in which a user may interactively “click” (using the hand-held controller 106) on one or more links, advertisements, images, people, objects, etc., in the program, causing the Internet browser on her computer 108 to direct to a website corresponding to her clicked selection. For instance, if the program is a news program, the anchor (represented by 103 in FIG. 2) may instruct the television audience to “click” on the link below for further information about a particular story or news item. When the user does so, the controller 106 (possibly but not necessarily in conjunction with transceiver 104) sends an instruction to computer 108 to cause its Internet browser to direct to a webpage (that may or may not be affiliated with the local television broadcaster) that provides additional information about the story or news item.

A wealth of information may be found on a newspaper's or television broadcaster's website that may not be possible to include in the newspaper or broadcast. Thus, the public broadcast may be used to help a user navigate a website and find information of special interest to the user, by allowing the user to interactively click on those features, items, advertisements, etc., in the television program that he finds of special interest. Another example may be the television broadcast of the sale or auction of local items or services. In any 30-second commercial, instead of attempting to sell a single item (at great cost, because commercials are expensive), the commercial may include a wide variety of products and services for sale (which may be available only locally), such as by piling several products/services at a time on the display/monitor 102 and/or staggering short advertisements (e.g., 1-5 seconds each) back-to-back. If the user is interested, she can simply click the controller 106 to find out more information, in which case her Internet browser on computer 108 will immediately lead her to more relevant information.

The examples described herein are not intended to limit the scope of the present invention. Most of the embodiments described herein have represented simple versions for clarity of explanation. Many of the features of the embodiments described herein may be “mixed and matched” to satisfy individual design requirements, and the present invention includes all such variations to the extent possible.

The applicant includes the following additional aspects and embodiments as within the scope of the present invention.

### Interactive TV Children's Programming, Interactive with a Local School Board Website, Based on a Newspaper Website

Interactive Children's programming is children's programming interactive with the local school board. The local school board, school or University can offer interactive websites on the local newspaper website. Interactive children's programming is interactive with the affiliate local TV station. The TV station can broadcast conventional children's programming with commercials or infomercials directing and instructing children to interact with the school system website. Programmed conventionally 6:00 AM-8:00 AM. This can be in the form of a local news and variety show hosted by students and teachers. The local school board can sell advertising on their website which would help to balance the school board's budget. Local high school journalism classes can service the website while the local high school's computer class can create the website and input the stories.

### Interactive Real Cities™ Cable and Satellite Channel

The Real Cities™ Interactive Cable & Satellite Channel is based on the Real Cities™ Website. This Cable and Satellite Channel is Interactive and broadcasts 24 hours a day, 7 days a week. The television broadcast broadcasts news and features that appear on the Real Cities™ Website. The Real Cities™ Website is made up of news from local newspapers throughout the United States and the world. This website is the largest website in the world.

News and features from local newspapers, wire sources, and network affiliates are all combined to promote the Real Cities™ website. Editorial comment, sports and feature from throughout the U.S. and the world are presented interactively on TV. Television presents the headlines and editorial content. The Real Cities™ website presents content and features that would appear in the local newspaper. Obituaries, classifieds, auctions, real estate, Cars.com™, Career Builder™, all the features that make up the Real Cities™ Website are highlighted on the Cable Channel.

The Real Cities™ Website is so huge it is impossible to navigate it in its entirety. The mission of the Cable Channel is to broadcast the headlines and supporting video, and guide the viewer to the location of the feature or archive discussed. The Interactive Morning News Talk & Variety based on the Real Cities™ Website is the basis for this cable channel.

### Interactive TV Based on a Local Newspaper Website

Interactive TV based on the local newspaper website is the merging of two media into a new more efficient media, Interactive TV. TV and newspaper advertising on their own are inefficient forms of advertising. They both use estimates to gauge advertising viewers. They need to re-invent themselves through interactive TV.

The Real Cities™ Website is the largest website in the world. The Real Cities™ Website has 1800 affiliate sites. These websites are perfect for hosting local network TV websites. Cross-ownership of TV and newspapers is not affected since this is an alliance and not necessarily a merger. The newspaper network and the TV network align in a framework, where the local affiliates create their own agreements. Affiliate ownership is separate.

Through cross-selling, the local newspaper and TV affiliates can cross-sell each other's inventory. Increased inventory of the newspaper website will lower Prime Time rates and lower cpms. TV viewership brings eyeballs to the newspaper website. The local newspaper website can be an outlet for the TV network's creative studio. The creative studio can create websites and circulate creation of the websites by satellite to the newspaper affiliates. Local TV affiliates can offer local advertising, local creativity, local news, and local control to the affiliates.

Interactive TV has a lot to offer to the TV affiliate, the newspaper affiliate, the advertiser and the viewer. The TV affiliate gets a website without the overhead of maintaining it. This website can contain network programming websites on a local basis. Creative local news, editorial content, features, and contests are available to the affiliate. Since the broadcast and the website are separately owned, they can contain contrasting editorial content. An example of this would be point-counterpoint points of view.

TV advertising would work better, immediacy of the commercial, where a viewer could purchase an item or access an advertiser's inventory as soon as they see a commercial. TV affiliates could sell auctions, Cars.com™, Career Builder™ and all of the websites to their advertisers. Furthermore, the TV advertiser would have three mediums to chose from: TV, Internet, and print.

Demographic and geographic targeting of advertising would become more exact. Community message boards and network TV shows on the website can target the consumer more precisely. Rural areas of a large market can receive cost efficient advertising through message boards. The newspaper website is so large that viewers get lost and can never uncover the wealth of information within it. TV brings eyeballs to the farthest reaches of the website.

Some of the advantages of this invention include the following. It increases competition in a newspaper's monopolistic market by removing barriers for competitors' entry. By lowering the cost of newsprint, ink and delivery barriers, the electronic delivery of a website is more efficient. A television station has a ready audience that is able to use the website immediately. The newspaper brings its circulation to the TV station, the TV station brings its viewers to the website. One website can be used in multiple markets or multiple television stations. A website can target small remote rural markets through community message boards which is something television alone can't do. Multiple Message Boards will lower advertising costs for rural communities. Rural Communities will have access to large market television advertising and still target the community or demographic.

It lowers advertising costs for at least the following reasons. Increases television and website inventory in prime time and all day parts, increasing advertising efficiency and lowering cost. The website can offer websites for network programming such as a local website for Desperate Housewives™. This opens up local advertising in prime time for the small advertiser. The website is 24 hours a day, 7 days a week and isn't gone in 30 seconds. Television ads can be linked to the website where a viewer can get more information. A website is cheaper to build and maintain than print which needs newsprint, ink, and delivery.

It increases adverting efficiency for at least the following reasons. Cost per thousands in both television and the website will fall due to greater viewer ship and more inventory. More precise targeting of demographics. Message boards for communities, buildings, or entities are more efficient, i.e., The Empire State Building, The University of Miami, or a big employer like IBM. The smallest coffee shop can advertise on the message boards. The Interactive Morning News Talk and Variety and the Cable channel can guide viewers to various places on the website. Website viewer ship is more precisely monitored than either television or newspapers alone.

The Interactive Morning News Talk and Variety will be described as follows. Similar to Good Morning America™ and The Today Show™ with a local flair. Network feeds in which half-hour or hour portions are made up of the network shows. The remainder is produced locally and the whole thing is interactive with the website. National and local news and features would be interactive with the website. 30-second television commercials can be linked to the website. The website can furnish more information like a brochure or link the commercial to the advertiser's website. Immediacy and the full impact of the commercial can be captured. The website can handle advertising 24 hours a day, 7 days a week. The television show can guide viewers to surf the website features. Editorial teases, feature articles can all be promoted by the TV show.

Crossownership issues: A reason this has never been done before is because of crossownership laws of newspaper and television. The newspaper website and television do not violate crossownership rules. They are owned by separate entities with separate editorial functions. They can enter into revenue sharing without violating crossownership laws.

### Real Cities™ Interactive Morning News, Talk, and Variety Television Show Based on the Real Cities™ Website

The Real Cities Interactive morning News, Talk, & Variety Television Show is based on the Real Cities™ Website. The Real Cities™ Website is the largest Website in the world. The Real Cities™ Website is comprised of the websites of over 100 local daily newspapers throughout the United States. The Real Cities™ website is so large people get lost and never uncover the information that it offers. Television is the only medium that can uncover this wealth of information. In the future this website is only going to grow. The marriage of television and the Internet are destined to meet here.

Network news ratings have slipped 44% since 1980. Newspaper circulation has been in decline nearly as much. Advertisers need a new medium to reach viewers that is more efficient. This Interactive Morning News, Talk, & Variety Show is a solution. The target market is women ages 18-49. Features, settings, topics will appeal mainly to young women. Features for men ages 18-49 will be included. However, their target demographic will be strongest on the website more than the television show.

The Television Show will be produced at the local affiliate station level with features supplied by the affiliate's network. The producer will receive features from various sources. The suppliers of features include, but are not limited to: Network Producers, Network Affiliates, Newspaper Affiliates, Independent Production companies, Wire Services, Satellite Correspondence, Internet Affiliates, Internet Websites, Internet Auction Sites, Local Correspondents, Archives, and International Sources. The show may air in the morning, between 7:00 a.m. and 10:00 a.m., but it is not limited to this time period. During this time period or the time period selected, the producer will select features. The show is not limited to features only from the Real Cities™ Website. However, Real Cities™ interactivity must support the television show.

The show will be the definitive source for local news, features, and content about the local market. However, it will not be limited to the local market. Through the website, the viewer interactively will have access to the websites of the Real Cities™ Community. News and features of interest from other cities will be aired on the show. The website, accessed 24 hours a day, enables viewers to access information from other cities' news and current events.

### Auctions, Shopping & Classifieds

Local Television is not able to offer auctions & classifieds due to time constraints. However, Interactive television opens up this whole world to the television viewer. Auction, & Classified Websites, from both local and the Real Cities™ community can be featured in segments during the Television show, such as Jobs, Cars, Real Estate, Rentals, Stuff, and Personals. To the Real Cities™ community, flexibility in advertising occurs. Television, Media, Newspaper, and internet advertising sales merge. Advertising consultants can buy multiple markets and multiple media. Career.Com™, Cars.Com™, Local Classifieds, Local Shopping, are not available to the local network affiliate presently, but through Interactive TV become available sources of revenue to the TV affiliate and network through commission and revenue sharing. Advertisers can purchase network and spot advertising, during the show and during daily programming which are tied to the Real Cities™ websites. Both local and national online shopping can be promoted by the television show.

Local television includes a network affiliate or independent station that broadcasts from a single market but may broadcast into other markets through the use of cable or satellite. Examples are WTBS or WGN super stations which broadcast through cable and satellite into markets; these would be classified as local stations. ABC, NBC, CBS, and Fox would not be classified as local but their affiliates would be. Local newspapers include any newspaper whose circulation is predominately in one market. This does not preclude national newspapers like USA Today™ and the New York Times™ from expanding into local markets and becoming local newspapers with local websites.

Local newspapers can have local features, like local classifieds, and local advertising. However this does not preclude eBay™, Cars.com™, Career.com™ or any other internet advertiser from joining the newspaper website and becoming local. Internet advertisers can join the newspaper website and become local. National advertisers can join the website and become local.

### Premium Gift Interactive Cable and Satellite Channel

The premium gift interactive cable and satellite channel is an interactive channel devoted to giving away and selling premiums. Premiums include but are not limited to: Sports clothing, Sports memorabilia, articles in the Disney Store™, articles in the Time Warner Store™, clothing with logos attached, consumer goods with logos, media goods with media logos, consumer goods to promote movies, any goods given away or sold which promote other consumer goods. Like coupons in the newspaper, the premium gift channel can pay for a cable or satellite bill.

Tied to commercials on Network TV, and other channels, premiums can be sold and given away that promote various activities. Prime time television, Sex and the City™ Lingerie, Disney™ cruises, Martha Stewart™ Household Goods, Desperate Housewives™ Household Goods, Disney Store™, Time Warner Store™, football and baseball jerseys, media premiums, movie and music clothing, etc. All of these items can interactively be sold and given away and tied to media networks and cable channels.

### News

Local, National, and World news may be featured. Network affiliates receive feeds for breaking news. Network news is in the same form as today. However, interactive innovations from the website are featured. Viewers can read articles, opinions, editorials from the Real Cities™ community of columnists. The viewer can be guided by the television show. Local news would be similar to local news today. However, more thorough interactive reporting of news becomes available to the affiliate. Local message boards, community message boards, and company message boards would be available. Local advertisers regardless of size can target their market. These message boards can promote local events.

### Talk

A talk show format which is similar to Good Morning Americam™, The Today Show™, Fox Morning™, or any of the other television morning shows will be featured on the show. Features and Feeds from the network would be available to the affiliate. Columnists and feature writers from each of the Real Cities™ community newspapers could be available to the network producer. Outstanding editorial content could feature the columnist on the talk show. The local producer could also screen which features have local appeal. Local politics, education, zoning and development can be aired along with opinions and topics of community interest.

### Variety

The show may include musical guests whose biographies and music are available to be purchased interactively. Guests can be interviewed, can sell their opinions, and communicate interactively. Viewers can evaluate local amateur entertainment auditions interactively. Cooking, Garden, Health, Life Style, etc., can be featured as soft entertainment with more information available on the website interactively, as well as local cooking and home improvement features. Advertising specialists can coordinate advertising to correspond to the feature.

### Sports

Local and national sports columnists can be featured. Sports personalities and scoreboards can each have a segment. The Real Cities™ website can interactively offer the viewer in-depth analysis of local, national, and world sports. Men ages 18-49 and men ages 18-34 can best be reached on this website. Local sports memorabilia websites which appeal to the local sports market could have segments. Reporting on local high school athletics could be made available on the website which is not covered in national sports magazines.

### Business

Local and National business geared towards the women can be featured. Expanding business websites for women is an area that Real Cities™ can expand.

### Entertainment

Local entertainment which includes movies, dining, clubs, theater, and sports can be featured on the show. Evaluations, reviews, and promotions can be included, and tickets can be interactively either auctioned or sold. Directions to restaurants or clubs can be given interactively. Movie commercials and reviews can be viewed, with tickets purchased at the same time. Television promotion and reviews may promote shows programmed later that day. Interviews with soap opera stars could promote a time of day which is very difficult to promote.

### Travel

Business and leisure travel can be coordinated from the website. A travel editor can feature value travel packages within the United States as well as abroad. Business travel can coordinate an itinerary from dining to entertainment for any Real Cities™ destination. These can be accessed through the website and promoted on the air.

What is claimed is:

1. A method for interactive education, comprising:
publicly broadcasting an educational program at a first time;
inciting a user to record the educational program;
inciting a student to view the educational program at a second time later than the first time;
inciting the student to use a computer processor and an information connection to log into an education server; and
inciting the student to input information regarding the educational program into the education server.

2. The method as claimed in claim 1, further comprising broadcasting a commercial advertisement immediately before, during, or immediately after the educational program.

3. The method as claimed in claim 1, further comprising:
inciting a local television broadcaster to merge with a local newspaper to thereby free resources; and
using the freed resources at least in part to produce the educational program.

4. The method as claimed in claim 1, wherein the input information corresponds to at least one of: answers to a test related to the educational program; a question related to the educational program; and attendance related to the educational program.

5. The method as claimed in claim 1, wherein the first time occurs at some period between 12 a.m. and 6 a.m.

6. The method as claimed in claim 1, wherein the second time occurs at least two hours after the first time.

7. The method as claimed in claim 1, further comprising:
communicating a web address through the educational program; and
inciting the student to use the computer processor and the information connection to access information identified by the web address.

8. The method as claimed in claim 1, further comprising:
communicating information corresponding to a web address through the educational program; and
causing the student to access information identified by the web address via the computer processor and the information connection, said causing comprising at least one of:
transmitting a sound that is receivable and decodable by the computer processor; and
transmitting electromagnetic radiation that is receivable and decodable by the computer processor.

9. A method for interactive education, comprising:
publicly broadcasting an educational program;
inciting a student to use a computer processor and an information connection to log into an education server;
inciting the student to input information regarding the educational program into the education server;
communicating a web address through the educational program; and
inciting the student to use the computer processor and the information connection to access information identified by the web address.

10. The method as claimed in claim 9, wherein the web address corresponds to a website of a local television broadcaster.

11. The method as claimed in claim 9, wherein the web address corresponds to a website of a local newspaper.

12. The method as claimed in claim 9, wherein the educational program is affected at least in part by the information input by the student.

13. The method as claimed in claim 9, further comprising broadcasting a commercial advertisement immediately before, during, or immediately after the educational program.

14. The method as claimed in claim 9, further comprising:
inciting a local television broadcaster to merge with a local newspaper to thereby free resources; and
using the freed resources at least in part to produce the educational program.

15. The method as claimed in claim 9, wherein the input information corresponds to at least one of: answers to a test related to the educational program; a question related to the educational program; and attendance related to the educational program.

16. A method for interactive education, comprising:
publicly broadcasting an educational program;
communicating information corresponding to a web address through the educational program; and
causing a student to access information identified by the web address via a computer processor and an information connection, said causing comprising at least one of:
transmitting a sound that is receivable and decodable by the computer processor; and
transmitting electromagnetic radiation that is receivable and decodable by the computer processor.

17. The method as claimed in claim 16, further comprising providing the student with a hand-held controller connected to the computer processor and configured to provide a point sight on a display displaying the educational program and to read the information corresponding to the web address.

18. The method as claimed in claim 16, wherein said causing comprises transmitting a sound that is receivable and decodable by the computer processor.

19. The method as claimed in claim 16, wherein said causing comprises transmitting electromagnetic radiation that is receivable and decodable by the computer processor.

20. The method as claimed in claim 16, wherein said publicly broadcasting comprises at least one of radio television broadcasting, cable television broadcasting, and satellite television broadcasting, and does not comprise Internet broadcasting.
